(19) United States
(12) Patent Application Publication
(10) Pub. No.: US 2024/0161118 A1
(43) Pub. Date: May 16, 2024

(54) Integrated System and Method for Smart Contract Creation, Asset Registration, and Blockchain Integration with Consensus Order and Wallet Transactions

(71) Applicant: Evrica Technologies Inc., Culver City, CA (US)

(72) Inventors: Anna Sarkisyan, Culver City, CA (US); Blake Rice, Culver City, CA (US); Evgenii Khromin, Culver City, CO (US); Ivan Sinitsyn, Culver City, CA (US); Kirill Lopurko, Culver City, CA (US); Iakov Baturov, Culver City, CA (US)

(73) Assignee: Evrica Technologies Inc., Culver City, CA (US)

(21) Appl. No.: 18/395,420

(22) Filed: Dec. 22, 2023

Related U.S. Application Data
(60) Provisional application No. 63/435,441, filed on Dec. 27, 2022.

(51) Int. Cl. G06Q 20/40; G06Q 20/10; G06Q 20/36; G06Q 20/38; G06Q 20/42

(52) U.S. Cl. CPC G06Q 20/405; G06Q 20/10; G06Q 20/36; G06Q 20/3827; G06Q 20/389; G06Q 20/42

(57) ABSTRACT

Disclosed embodiments integrate jurisdictionally compliant smart contract formation, the fusion of automated transactions with professional services interfaces, and the ability to handle the complexities of modern commerce within a decentralized framework. Disclosed systems may include multiple blockchain storage of hashed data sets during the formation and negotiation of smart contracts with integrated asset verification and digital wallet creation and use. Disclosed embodiments include a comprehensive ecosystem that ensures security, transparency, ease of verification and robustness tailored for contemporary business needs.

### RELATED PATENT APPLICATION AND INCORPORATION BY REFERENCE

This utility application claims the benefit and priority of U.S. application 63/435,441 filed on Dec. 27, 2023 the contents of which are incorporated herein by reference as if restated.

### COPYRIGHT AND TRADEMARK NOTICE

The material disclosed in this application may be subject to copyright, trademark, and/or other intellectual property rights. The copyright and trademark owner(s) grants permission for the facsimile reproduction by anyone of the patent documentation or disclosure as it appears in the U.S. Patent and Trademark Office's patent file or records but reserves all other rights whatsoever. The term “Evrica” may be a registered trademark, and its use here is to provide a contextual reference to the innovative embodiments disclosed.

This application pertains to proprietary systems, methodologies, and implementations, including but not limited to, processes related to the creation, management, and execution of legal smart contracts through the integration of artificial intelligence, blockchain technology, and user authentication mechanisms. The platform, branded as “Evrica”, seeks to provide a novel solution for the automation of transactions and payments, the intelligent assembly of jurisdictionally-compliant legal smart contract templates, risk calculation using AI, and a comprehensive user wallet tied directly to said contracts, supporting both cryptocurrencies and fiat currencies through a strategic integration with verified digital wallets, such as “Stripe”.

Part of the distinctiveness of Evrica lies in its use of the Binance smart-chain or other multifunctional blockchain platforms, zk rollups, and adherence to a zero-trust models for security, coupled with robust encryption methods. Every user undergoes rigorous verification through ID.Me to ensure authenticity. The innovation extends to the assembly and storage of legal contract templates directly in the blockchain, solidifying them as immutable, transparent, and verifiable legal smart contracts. While the platform envisions the release of a utility token at a subsequent phase, the primary focus remains on creating a transformative ecosystem for legal smart contracts.

### BACKGROUND OF THE INVENTION

### (1) Field of the Invention

The invention intricately pertains to the fusion of contract formation, asset transfer, document management, and accounting in a decentralized blockchain environment, primarily through the lens of legal smart contracts. Leveraging artificial intelligence, Evrica introduces an innovative approach to assembling jurisdictionally compliant legal contract templates, thereby transforming traditional professional services and business tools. This system prioritizes automation in transactions and payments, coupling it with sophisticated risk calculation algorithms and offering a comprehensive digital wallet experience that bridges both cryptocurrencies and fiat currencies in a seamlessly integrated manner.

### (2) Description of the Related Art

While blockchain technology and electronic document systems have made strides in recent years, the current state of the art has notable shortcomings. Existing solutions in the related art often lack the integration of AI-driven, jurisdictionally compliant smart contract formation, the fusion of automated transactions with professional services interfaces, and the ability to handle the complexities of modern commerce within a decentralized framework. Most critically, while there are mechanisms to perform electronic transactions, there remains a conspicuous absence of a comprehensive ecosystem that ensures both security and robustness tailored for contemporary business needs. Hence, the art greatly benefits from the unique advancements presented in the disclosed embodiments of the Evrica platform.

### BRIEF SUMMARY OF THE INVENTION

The disclosed embodiments address the gaps in the related art by introducing innovative combinations and configurations that stand apart from the norm. This invention harmoniously melds NFTs and decentralized blockchain systems with a unique twist: while maintaining decentralization, it assures secure user history records. The platform doesn't just stop at document and contract creation; it elevates these processes by offering capabilities for advanced document editing within a cohesive ecosystem. This ecosystem is designed not only for document and contract management but also serves as a bridge to professional services. With integrated gateways tailored for fields such as legal and accounting, the disclosed embodiments ensure interactions remain secure while streamlining professional engagements.

### BRIEF DESCRIPTION OF THE DRAWINGS

FIG. 1 is a block diagram of a system and data structure for creating a smart contract

FIG. 2 is a block diagram of a system and data structure for storing data in a decentralized blockchain registry

FIG. 3 is a block diagram of a system and data structure for a user wallet

FIG. 4 is a block diagram of a system and data structure for asset registration

FIG. 5 is a block diagram of a system and data structure for creating a smart contract using a registered asset

FIG. 6 is a block diagram of a system and data structure for initiating correspondence to create a new document or other item between system users

FIG. 7 is a block diagram of a system and data structure for the creation of a smart contract template editor

FIG. 8 block diagram of a system and data structure for a sequential method for creating a smart contract

FIG. 9 is a block diagram of a system and data structure for storing data in a decentralized blockchain registry

FIG. 10 is a block diagram of a system and data structure for using a system wallet

FIG. 11 is a block diagram of a system and data structure for the registration of assets within a disclosed system and blockchain registry

FIG. 12 is a block diagram of a system and data structure for creating a document with added system assets

FIG. 13 is a block diagram of asset, system and contract processes

FIG. 14 is a block diagram of systems of schemes of asset tokenization

FIG. 15 is a block diagram of crowd funding with disclosed token systems

FIG. 16 is a block diagram of systems or schemes of contract tokenization and automation.

### REFERENCE NUMERALS IN THE DRAWINGS

100 sequential scheme for creating a smart contract
110 contract database
115 Registered user chooses type of contract from template and jurisdiction
120 draft of contract saved in registry
125 user filled out clauses with data, assembling the contract
127 status one
130 notifications sent to invited users
135 user chooses key parties, sends invitation for signing the contract to other users with consensus order
137 status 2
140 signed contract saved as NFT
145 users sign the contract
147 status 3
200 scheme for storing data in a decentralized blockchain registry
210 user enters data into a pre-created template while assembling the smart contract of relevant jurisdiction
215 generation and storage of has number
220 user chooses key parties, sends invitation for signing the contract to other users with consensus order
230 parts can choose to make amendments for verification, amended file is sent for approval to the other parties
240 users sing the contract in chosen order (consensus scheme)
254 status 4
300 scheme or methods of a disclosed user wallet
310 user connects existing bank account, and other traditional accounts such as paypal and/or a cryptocurrency wallet
320 user may pay for services as specified in a smart contract or send funds to other registered users independently
330 depending on the terms set in the contract, funds may be frozen or otherwise held in escrow on the account of the users
340 if the contract terms are deemed completed by the parties, an users verify, the funds are disbursed automatically upon confirmation
400 scheme or system for asset registration
410 user enters data into a template or form, entering relevant data for the registration of each asset
420 data proved by the user is entered for verification
430 in the case of improper data entry, the asset registration is declined
440 in the case of confirmed verification, the asset status is deemed confirmed and included in the asset registry
500 scheme or system for creating a smart contract using a registered asset
510 user enters data into a pre-crated form while assembling the smart contract of relevant jurisdiction
520 in the data or form of a smart contract, a user can add a registered asset into the contract terms
530 user chooses key parties, send invitation for signing the contract to the user users with consensus order
540 parties can choose to make amendments for verification, amended file is dent for approval
550 user sign the contract in chosen order (consensus scheme)
600 scheme or system for initiating correspondence to create a new document between users
610 the user, when creating a new document for signing with other users, will be able to open a “dispute” in the “correspondence” section
620 the user invites other users with whom the document will be signed
630 all correspondence, as well as attached filed, cannot be deleted and are part off a history or providence of a further singed document between users
640 users can invite a verified user, such as a lawyer, of the system to participate in the correspondence and approval of the document
700 new smart contact template editor scheme
710 verified system attorney creates document template
720 fills out the text of the agreement/smart contract
730 each section may have its own descriptor that will amend the agreement clauses
740 depending upon the relative size and type of agreement, makes edits
750 user may edit the agreement by filling in the blanks
760 saves document
770 in the settings of steps and descriptors, user can edit inputs
800 sequential scheme or system for creating a smart contract or document
810 user one creator
820 system in general for the initial steps of a creator
840 data entry for smart contact formation
860 user two signatory system
900 scheme or system for storing data in a decentralized block chain in registry
910 system of data creation by a first user or creator
940 system of a second user or signatory
980 block chain transaction monitoring service
1000 scheme or system of using or creating a system wallet
1010 server and bank systems
1060 options for using a wallet balance
1100 data entry system
1170 asset verification system
1180 server database system
1190 blockchain system
1200 sequential system or scheme for crating a document with added
assets
1210 initial steps for registration and construction of document
1260 registration of asset system
1280 server database
1290 user two or signatory system
1300 system process
1400 system or scheme of asset tokenization
1500 crowdfunding with system tokens
1600 system and scheme of contract tokenization and automation

These and other aspects of the present invention will become apparent upon reading the following detailed description in conjunction with the associated drawings.

### DETAILED DESCRIPTION OF EMBODIMENTS OF THE INVENTION

The subsequent detailed description delves into specific embodiments associated with the invention. However, it's pivotal to understand that the breadth of this invention spans beyond the particularities discussed here, encompassing a plethora of variations as encapsulated by the claims and their equitable interpretations. For ease of understanding and coherence, references made to the accompanying drawings will consistently use like numerals to indicate analogous components throughout.

Unless otherwise noted in this specification or in the claims, all of the terms used in the specification and will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The disclosed embodiments, occasionally termed as “Evrica,” can manifest in various formats. This includes an interactive online interface, standalone software, or as an application tailored for compatibility with smartphones and other personal electronic devices. The primary utility of these embodiments revolves around facilitating electronic document management amongst its users. Importantly, these users span a wide spectrum, encompassing both formal legal entities and individual private users.

The disclosed embodiments offer the capability to register and log documents within a decentralized ledger, leveraging advanced blockchain systems. Digital assets aren't merely stored; they're intricately integrated or mapped within smart contracts, streamlining transaction executions. Beyond this, the embodiments encompass a suite of functionalities: from robust analytics systems to an intuitive editor designed for document creation. They facilitate seamless online payments between users and uniquely position users to access expert insights, allowing them to interact with and obtain advice from professionals, such as attorneys and financial experts, verified and registered within the system.

The disclosed embodiments, at times operating within a blockchain framework or ecosystem, have the capability to facilitate transactions between entities seamlessly. This not only involves uploading pertinent entity information but also entails the intelligent assembly of smart contracts, tailored to the specific jurisdiction and agreement type. Users can select an appropriate consensus scheme, and the system allows for the transfer of rights tied to registered assets or the execution of payments. These payments can be made using a mix of regulated stable coins, cryptocurrencies, or traditional fiat currencies, all seamlessly connected to one's bank account within the digital wallet. Designed with user-centricity in mind, the system features an intuitive, user-friendly UI. Post-transaction, each transaction gains permanence, being encapsulated as an NFT, each marked with a distinctive hash-code.

The disclosed embodiments provide complete transparency and a viewable history, improving the ease of performing due diligence and providing complete transparency for businesses of all types and of all sectors. The disclosed embodiments redefine smart contracts between users. Users are able to register in the software using a subscription-based model, and the moderators/administrators are either IT or external attorneys. Upon registration, a business or private entity submits its legal documentation and confirms its identity. They choose the jurisdiction for the transaction, include relevant clauses, and send for approval in the consensus scheme they deem appropriate with as many parties as needed. Registered NFTs and assets are stored in the blockchain.

The disclosed embodiments encompass a system, ecosystem, or software designed with a core principle: fostering heightened transparency in transactions. This design philosophy not only bolsters trust amongst users but also ensures a meticulously documented and traceable record of all activities. Every transaction based on the legal smart contract, alongside the behavior and conduct of registered users, is cataloged in a manner that epitomizes clarity and accountability.

The disclosed embodiments prioritize user experience by championing an interface-centric design while seamlessly consolidating data pertinent to transactions, asset management, and fiscal requirements. What sets these embodiments apart is their innovative integration of self-executing legal smart contracts archived within the blockchain, ensuring both adaptability and robust security.

Functionality or system attributes of the disclosed embodiments may include:

Users can seamlessly register within the system, gaining access to a personalized account. This registration process requires users to verify their identity (using both internal/external verification such as ID.me) and input personal credentials, including, but not limited to, taxpayer IDs. Moreover, users are prompted to upload documentation that substantiates their registration, alongside other personal details like email, registered address, and biometric data, all in alignment with the system's internal protocols and parameters. Users will also need to upload information verifying their business establishment, including TIN, certificate of good standing, and other relevant documents.

Once registered, a user can draft contracts with fellow users by assembling pre-designed jurisdictional compliant templates, and input the requisite details to finalize the document.

A user can sign the created document with other users within the system software by issuing an invitation to sign the document. The creation, order of signing, and other document attributes, terms and methods of execution may be dictated by a system consensus scheme.

Counteroffers, amendments, and comments are uploaded to the contract before signing and sent out for confirmation or edits from the other users.

Upon signing by all parties, the smart contract is rendered or deemed complete or executed and the smart contracts are stored in the user's personal account along with the entire history of changes that are recorded in the decentralized registry (blockchain). Users can also upload their own agreements and send them to signatories with a bespoke consensus scheme. Both the assembled legal smart contracts and uploaded contracts are stored on the blockchain after all signatures have been completed. The history of document changes can be useful in future disputes regarding the meaning of terms.

Within their personal account, users have the capability to catalog both tangible and intangible assets they own. These assets are subsequently logged within a decentralized ledger, specifically the blockchain.

Within the disclosed embodiments, any “asset” registered can be seamlessly incorporated into a legal smart contract. This allows users to exercise various rights and actions pertaining to the asset, including transferring ownership, licensing, leasing, selling, or even donating it to other users within the framework of the crafted agreements and contracts.

Should a monetary amount be specified in the documents or be due under the terms of a system-generated smart contract, such consideration can be paid or transferred via the integrated Wallet within their personal account. This Wallet supports a diverse range of payment methods, encompassing cryptocurrencies, stable coins, and fiat currencies using traditional bank account transfers.

The disclosed embodiments also empower users with the flexibility to craft bespoke contract clauses and provisions. This capability ensures that users aren't solely confined to the system's predefined clauses and can introduce their own tailored stipulations as needed.

Templates of documents, contracts, and agreements may be modeled, drafted or entered by verified system users in the template editor.

Using hyper-secure encryption and decryption, the executed contract has its own unique code that's stored in the blockchain as NFTs and decrypted into a signed PDF if necessary.

The user, using the “Upload Contract” service, uploads a digital file containing the text of the document in the doc/pdf/jpg format to the system. This file is recognized and converted into a digital smart contract. The contract is verified by the system administrator and made available for saving, signing to the System Users.

The systems and methods disclosed herein uniquely integrate several features to create a comprehensive B2B legal smart contracts platform, named “Evrica.” The core functionality enables the assembly, automation, and execution of legal contracts that are both smart (i.e., self-executing) and compliant with various jurisdictions. This is achieved through:

AI-Driven Assembly: The integration of Artificial Intelligence (AI) to assemble these contracts based on the requirements of the users and the specifics of the jurisdiction involved. The proprietary transactional compliance AI, for which a separate patent has been filed, calculates risks associated with the drafted contracts, ensuring that they remain compliant with the appropriate legal standards.

Blockchain Storage: The assembled legal contract templates are not just stored but are embedded in the blockchain. This ensures the immutability, security, and authenticity of the contracts. The platform primarily utilizes Binance Smartchain and enhances scalability and privacy through the implementation of zk-rollups.

Verification and Security: A robust zero-trust model is employed, fortified with best-practice encryption protocols. User verification is carried out through ID.Me, providing an additional layer of identity confirmation.

Integrated Wallet System: Every user is equipped with a digital wallet that's intrinsically tied to the legal smart contract. This wallet supports both cryptocurrencies and fiat currencies, made possible through the integration of digital wallet capabilities (e.g. “Stripe”). As a result, automated transactions and payments related to the contract are seamlessly facilitated.

Open Connectivity: The platform provides an interface for users to connect to various software solutions and digital databases, including but not limited to financial, banking, accounting, and analytical systems, through an enhanced internal program interface (API). This seamless connectivity augments the flexibility and adaptability of the platform.

In addition, plans for a utility token release are underway, which will further enhance the ecosystem's functionalities.

A verified User of the “Evrica” platform is endowed with an integrated “Wallet” service. This wallet, intrinsically tied to the user's legal smart contracts, grants the user capabilities to:

Multi-currency Transactions: Seamlessly conduct financial and banking transactions with other users. This includes operations involving traditional fiat currencies through connected bank accounts.

Cryptocurrency Management: Safely store, receive, and send various cryptocurrencies or digital assets.

Token Compatibility: Specifically designed to be compatible with a wide array of token standards, the wallet prominently supports ERC20 tokens among others, ensuring users have flexibility in their transactional preferences.

Advanced Security: All blockchain transactions conducted via the wallet adhere to the AES-256 encryption standard, reinforcing the platform's commitment to secure, reliable, and confidential operations.

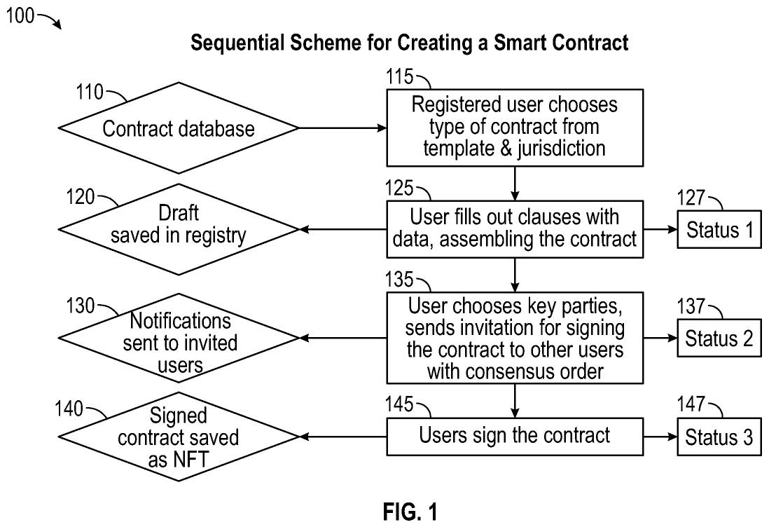

Referring to FIG. 1, a sequential method 100 for creating a smart contract is illustrated. In a disclosed embodiment, a contract database 110 presents a registered user various types of contract 115 from various templates to comport with a selected jurisdiction. A user may fill out clauses 125 with data, assembling the contact, a draft of the contract may be saved in a registry 120.

A user may choose 135 key parties, send invitations for signing the contract to other users with a consensus order. Notifications 130 may then be sent to invited users. Users may sign the contract 145 and the signed contract may be saved 140 as a NFT.

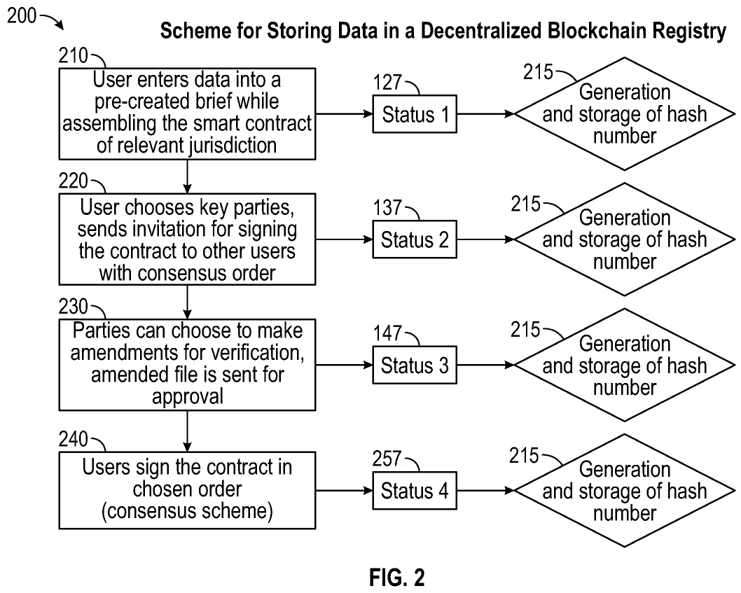

Referring to FIG. 2, a method 200 for storing data in decentralized blockchain registry may start with a first step 210 of a user entering data into a selected pre-created template while assembling or drafting the smart contract designed for a selected or relevant jurisdiction. The work may be saved, encrypted or transmitted via a generation 215 and storage of a hash number.

Another step may involve a user selecting 220 key parties, sending an invitation for signing the contract to other users with a consensus order. This information may be saved, encrypted or transmitted via a generation 215 and storage of a hash number.

A next step may involve users signing 240 the proposed contract in a consensus order or consensus scheme. The documentation may be saved, encrypted or transmitted via a generation 215 and storage of a hash number.

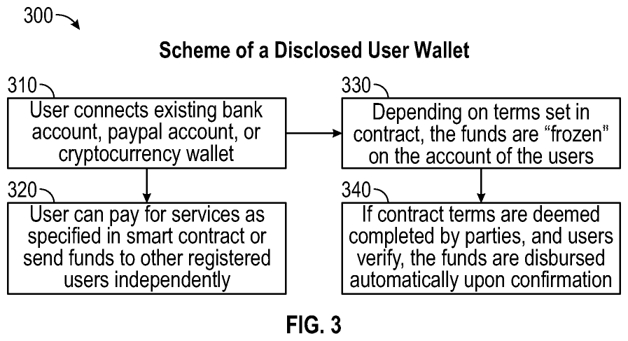

FIG. 3 presents a system or scheme of a disclosed user wallet 300 wherein a user connects 310 an existing bank account, other type of account or cryptocurrency wallet. In another step, users can pay 320 for services as specified in a smart contract or send funds to other registered users independently. After a bank account is connected, and depending upon the terms of the contract, funds may be “frozen” 330. In another step, if the contract terms are deemed completed 340 by the parties and the users verify, the funds may be unfrozen and disbursed automatically upon confirmation that all conditions have been met.

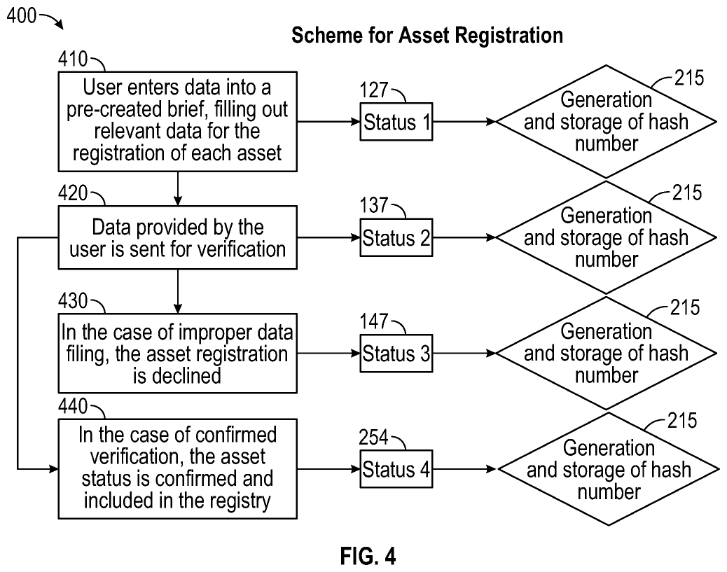

FIG. 4 presents a system, method and/or scheme for asset registration 400. After a step is completed, the work or data may be used to generate and store a has number 215. In a first step 410 a user may enter data into a pre drafted template 410. In a second step 420 data provided by the user is sent for verification. In a third step 430, in the case of improper data entry, the asset registration is declined. In a fourth step 440, in the case of confirmed asset verification, the asset status is confirmed and included in the registry.

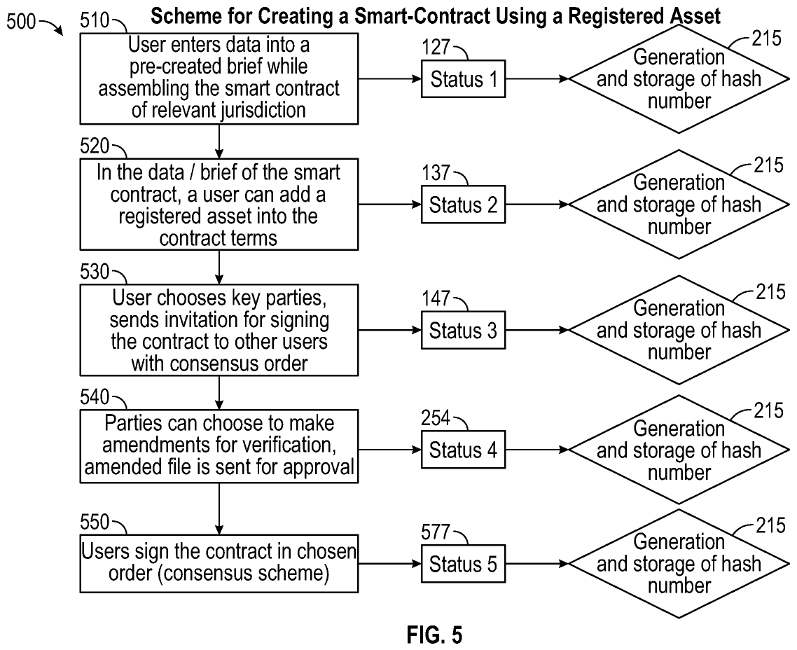

FIG. 5 presents a method, system and/or scheme for creating a smart contract using a registered asset 500. After each step, a status may be achieved and the data may be used for the generation and storage of a hash number 215. In a first step 510 a User enters data into a pre-created brief while assembling the smart contract of relevant jurisdiction. In a second step 520 a user may add a registered asset into the contract terms. In a third step, a user chooses key parties, sends invitations for signing the contract to others using consensus s order. In a fourth step 540, parties can make amendments for verification, and the amended file is sent to other parties for approval. In a fifth step 550 users may sign the contract in the chosen order.

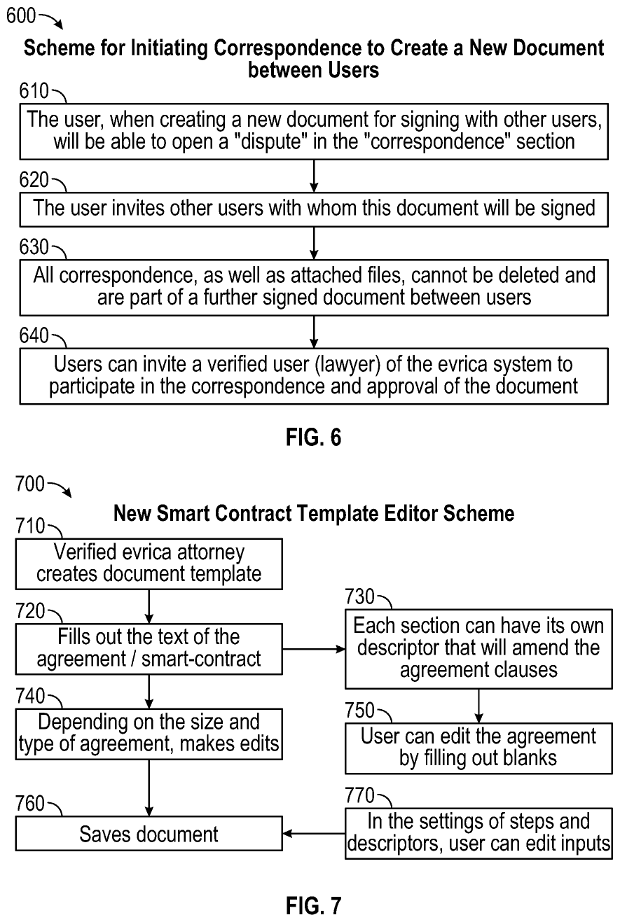

FIG. 6 presents a method, system or scheme for initiating a correspondence to create a new document between system users 600. Such a process may be used to initiate is dispute proceeding. In a first step 610 a user, when creating a new document for signing with other users, will be able to open a “dispute” in the “correspondence” section. In a second step, the user invites other users with whom the document will be signed. In a third step, 630 all correspondence, as well as attached filed, cannot be deleted and are part of a history or providence of a further singed document between users. In a forth step 640, users may invite a verified user, such as a lawyer of the system to participate in the correspondence and approval of the subject document.

FIG. 7 presents a new smart contact template editor system 700. In a first step, a Evrica attorney or attorney having access to the system creates a document template 710 using system tools. In another step 720, a user may fill out text of the of the proposed agreement or smart contract. In another step 730 each contract section may have its own descriptor that will amend clauses in the proposed agreement. In another step 740, further edits may be made and the document may be saved 760. In another step 750 a user may edits the agreement by filling in blank parts. In another step, in the settings of steps and descriptor, a user can edit inputs and the document may be saved 760.

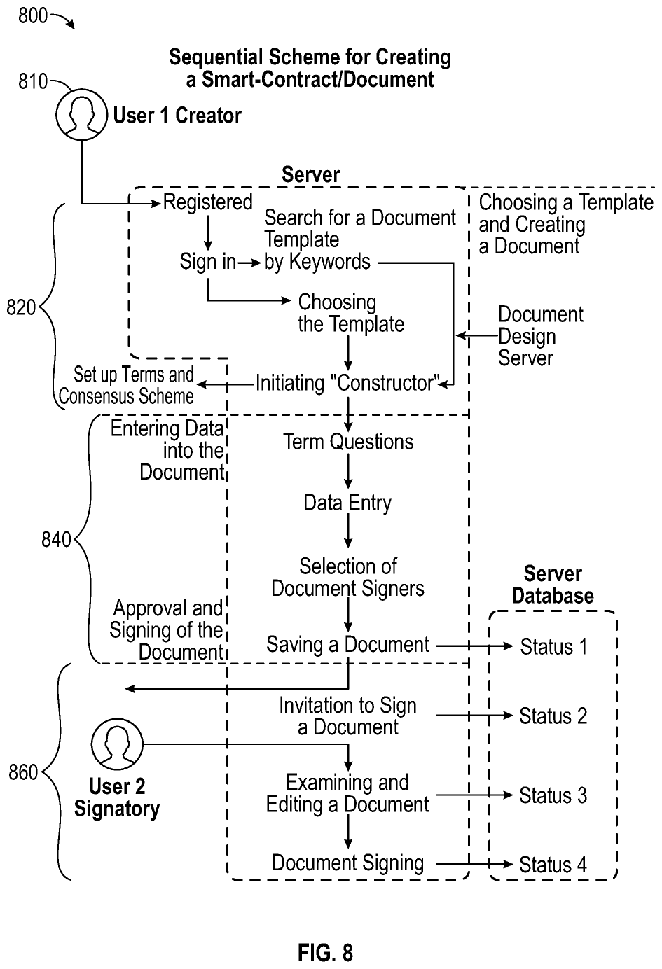

FIG. 8 presents a system or sequence 800 of wherein a first user 810 or creator begins a step 820 of registering upon a server, searching for a document template, choosing a template and initiating a constructor. In a next step, 840 a user enters data into the document, term questions section of document signers and the document is saved. In a next step, 860 a second user receives an invitation to review the document, reviews the document, makes counter offers or proposed revisions, and if agreeable, signs the document.

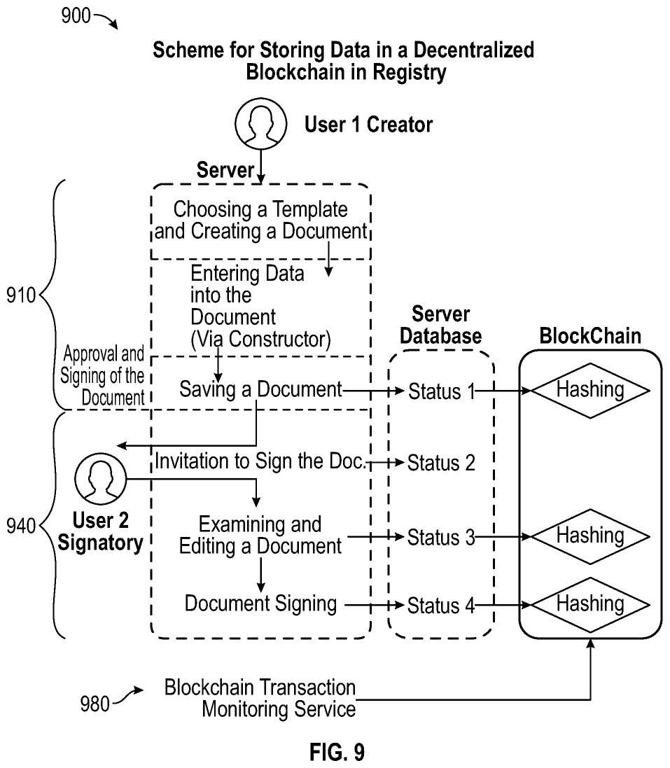

FIG. 9 presents 900 a system for storing data in a decentralized Blockchain in a registry. In a first step 910 a template is chosen and a document is started. Data is entered via a constructor and the document is saved and stored in a block chain after hashing. In a second step 940 a second user or signatory examines the documents and may edit the document with the edited document stored in a block chain after hashing. The document may be signed and stored in the block chain after hashing. The ending document may be subject to a 980 blockchain transaction monitoring service.

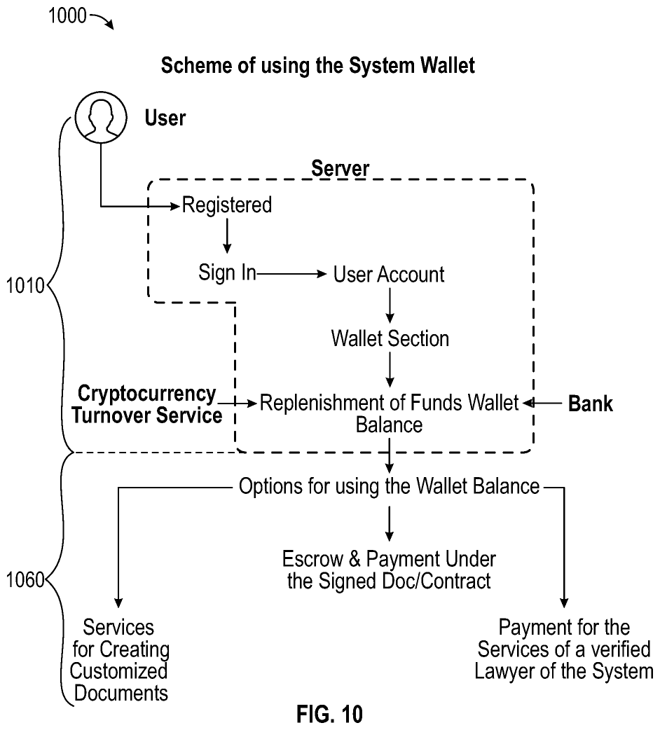

FIG. 10 presents a system 1000 or scheme of using a system wallet. In a first step 1010 a user signs in, selects a wallet and interacts with a cryptocurrency turnover service and/or bank to add funds to the wallet. In a second step 1060 a user may be presented with options for using a wallet balance such as using funds for services for creating customized documents, escrow and payments under a signed document or contract and/or payments for services of a verified lawyer of the system.

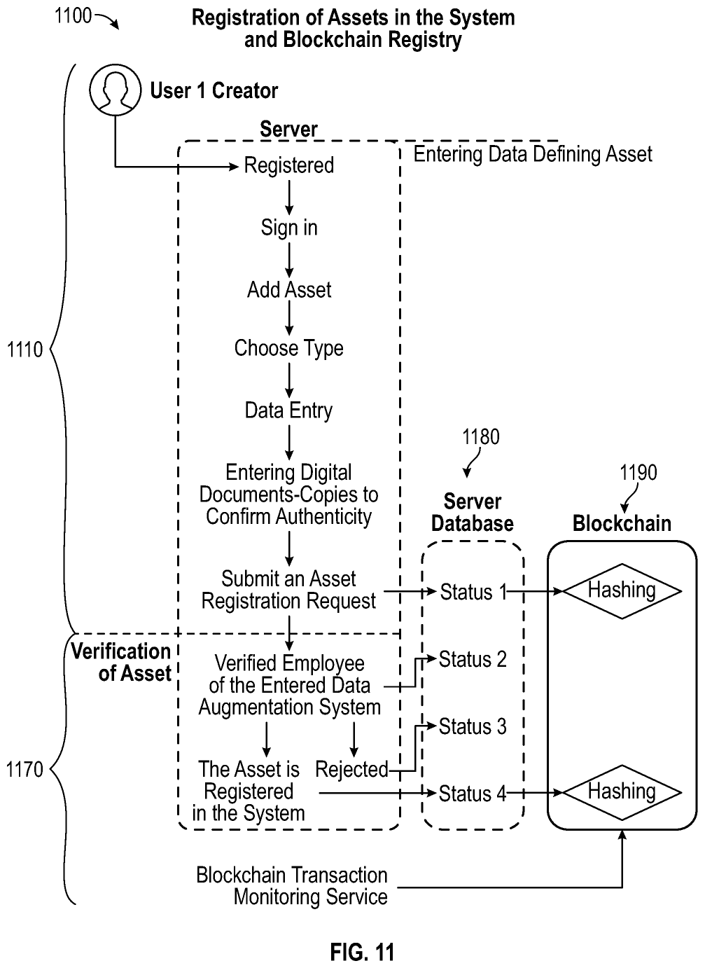

FIG. 11 presents a system 1100 of registration of assets within the system of and blockchain registry. In a first step 1110 a first user may register, add an asset, choose the type of asset, enter data, confirm authenticity of the asset by entering digital documents. In another step 1170 assets are verified with the results hashed and stored in the blockchain.

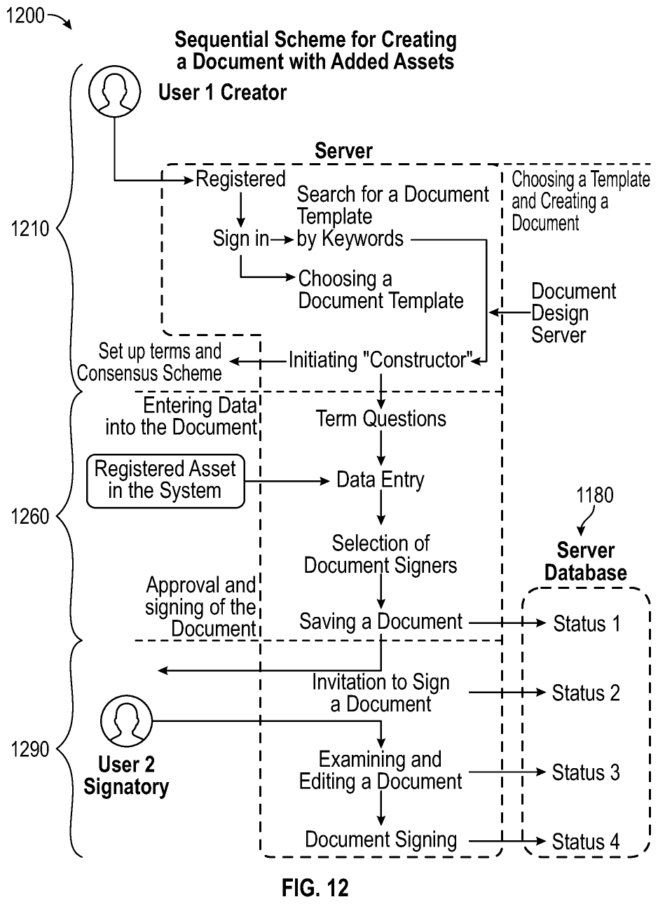

FIG. 12 presents a system 1200 or scheme for creating a documents with added assets. In a first step, 1210 registration and document template selection occurs. In anther step 1260 the asset is registered in the system. In another step 1290, a second user of signatory may sign the proposed agreement and the document is stored in the server database 1180.

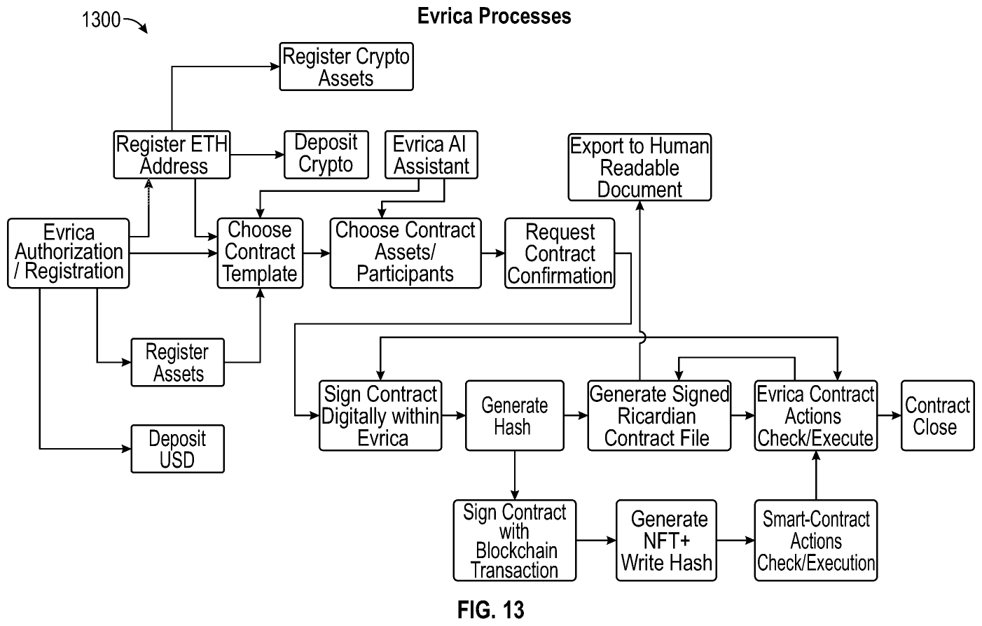

FIG. 13 presents a plurality of system processes 1300 or Evrica processes that may include the registration of crypto assets, the registration of ETH assets or Ethereum brand assets, a system assistant, the formation of digital contracts, the storage of hashed information within a blockchain system, the generation of NFTs or non fungible tokens, and the execution of smart contracts.

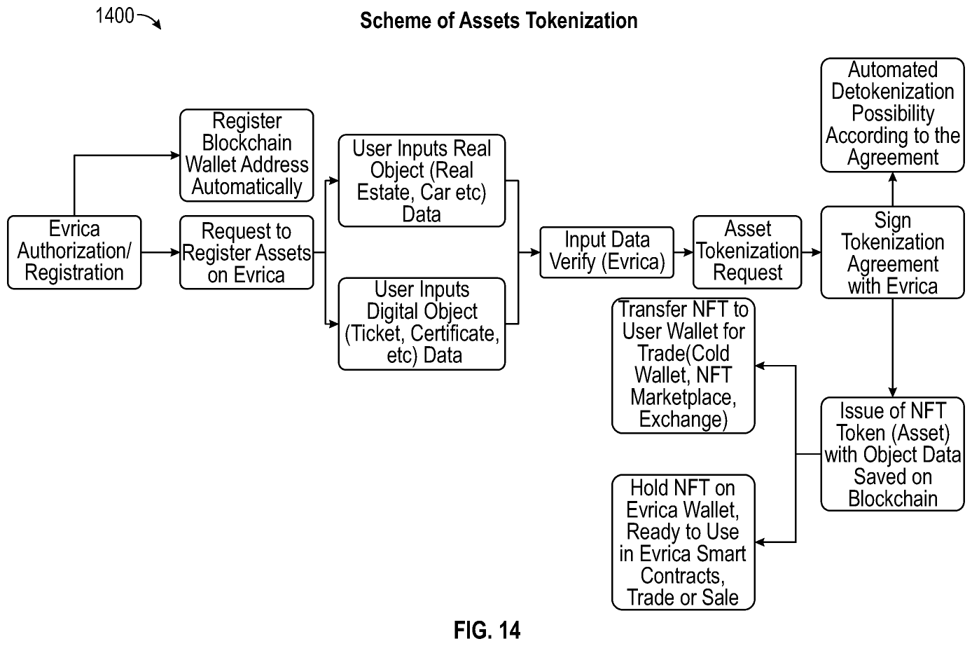

FIG. 14 presents a system 1400 of asset tokenization. The system may include user registration, the registration of blockchain wallet address, user inputs of assets that may be physical or digital, verification of assets, asset tokenization and integration with the disclosed smart contract and blockchain systems.

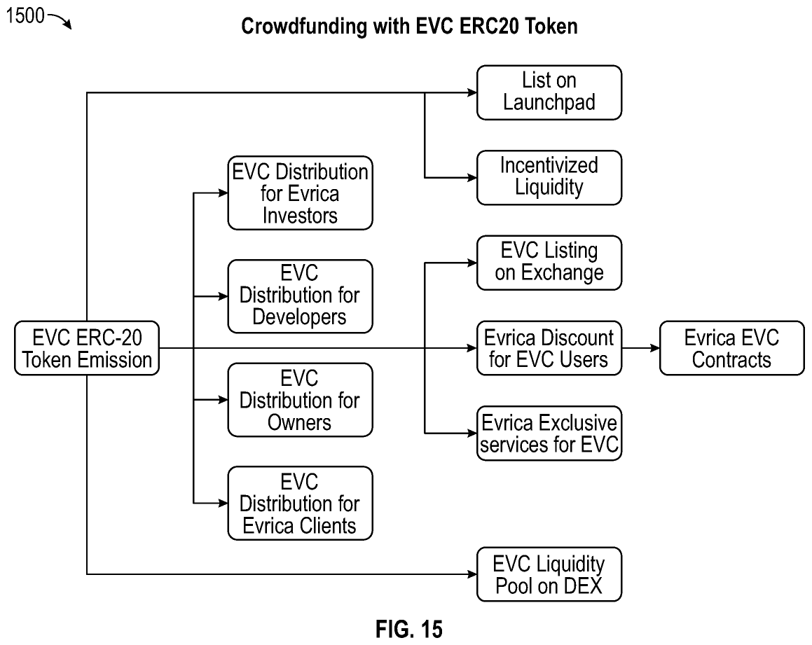

FIG. 15 presents a crowd funding 1500 system that may include the use of EVC ERC20 Tokens or eve Coin tokens sometimes used in a BNB Binance Smart Chain Mainnet. The system may include the integration of Evrica systems.

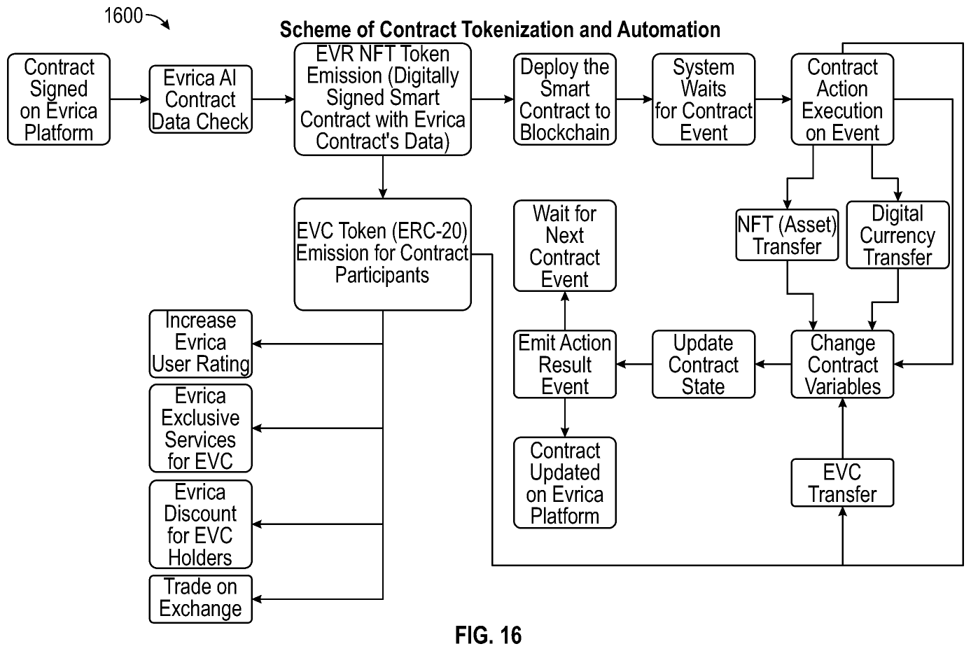

FIG. 16 presents a system 1600 of contract tokenization and automation using the Evrica systems describe herein.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A method for the creation of smart contracts, asset registration and block chain integration, the method comprising the steps of:
a) using a contract database (110) enabling a first user to select a contract template with the template keyed to a selected jurisdiction;
b) enabling the first user to add data to the contract template and saving the contract template into a registry (120);
c) enabling the first user to send invitations to other parties to sign the contract, the selection including a consensus order;
d) enabling a second user to sign the contract;
e) the system hashing the contract to create a hash value and the system storing the hash value in a blockchain.

2. The method of claim 1 further including the steps of:
a) enabling the first user and the second user to transmit a contract completed message to the system;
b) enabling the first user to create a user wallet within the system;
c) enabling the second user to create a user wallet within the system;
d) the system transferring assets from one wallet to the other upon receipt of the contract complete message.

3. The method of claim 2 further including the steps of:
a) enabling the first user to retrieve a system template for asset registration;
b) enabling the first user to enter data into the system template for asset registration;
c) the system confirming or declining the data of the first user entered into the system template for asset registration;
d) in the case of the confirmation of the data of the first user entered into the system template for asset registration, the confirmed asset status is recorded in the system registry.
